(19) United States
(12) Patent Application Publication
(10) Pub. No.: US 2008/0294817 A1
(43) Pub. Date: Nov. 27, 2008

(54) DATA TRANSMITTING APPARATUS

(75) Inventor: Kiyoshi Tsuneki, Kawasaki (JP)

Correspondence Address: YOUNG & THOMPSON, 209 Madison Street, Suite 500, ALEXANDRIA, VA, 22314, US

(73) Assignee: C/O NEC ELECTRONICS CORPORATION, Kawasaki (JP)

(21) Appl. No.: 12/118,892

(22) Filed: May 12, 2008

(30) Foreign Application Priority Data
May 22, 2007 (JP) 2007-135695

(51) Int. Cl. G06F 13/00

(52) U.S. Cl. 710/100

(57) ABSTRACT

Interface circuits are tested flexibly. Interface circuits 11a to 11d are coupled over a bus to a CPU 13 to receive data from or output data to each of external terminals of an external terminal set associated with each of the interface circuits. An interface test circuit 20 is coupled over a bus to the CPU 13. The interface test circuit 20 comprises a selection circuit that selects one of the interface circuits 11a to 11d, and selects whether data is to be received from or output to external terminals of the external terminal set associated with the selected interface circuit. In case the interface circuit operates as an outputting circuit, the interface testing circuit receives and buffers data output by the interface circuit in it so that the data can be read out by the CPU 13. In case the interface circuit operates as a receiving circuit, the interface testing circuit outputs data pre-written and buffered in it by the CPU 13 so that the interface circuit will receive the data (FIG. 1).

### REFERENCE TO RELATED APPLICATION

This application is based upon and claims the benefit of the priority of Japanese patent application No. 2007-135695, filed on May 22, 2007, the disclosure of which is incorporated herein in its entirety by reference thereto.

### FIELD OF THE INVENTION

This invention relates to a data transmitting apparatus. More particularly, it relates to a data transmitting apparatus having a test function for interface circuits taking part in data transmission.

### BACKGROUND OF THE INVENTION

High integration of semiconductor devices is progressing, and a system-on-chip (SOC) having main functions integrated on a single chip is becoming popular. Among the SOCs, there is such a one in which there are provided a CPU, a memory and an interface circuit, and in which the interface circuit is coupled over a bus to the CPU in order to transfer data between the CPU and an external device. Since the interface circuit is coupled with the external device, there is fear that, should failure in connection occur, it is not that easy to locate the site of the failure or to grasp its contents. It is thus customary that the semiconductor device is provided with a test circuit used for testing the interface circuit.

In Patent Documents 1 to 3, there are disclosed such an apparatus having a test circuit coupled in one-for-one correspondence with a sole interface circuit in order to conduct a test for the interface circuit.

### [Patent Document 1]

JP Patent Kokai Publication No. JP-A-1-280852

### [Patent Document 2]

JP Patent Kokai Publication No. JP-A-7-319781

### [Patent Document 3]

JP Patent Kokai Publication No. JP-A-7-21092

### SUMMARY OF THE DISCLOSURE

The entire disclosures of Patent Documents 1, 2 and 3 are incorporated herein by reference thereto. The following analyses are given by the present inventor.

Recently, in keeping up with the increasing size of the semiconductor device, an SOC has come to be provided with a plurality of interface circuits. To test the SOC's interface circuits, it is necessary to provide a plurality of test circuits, having inputs/outputs, the numbers of signal lines or the signal timings matched to the respective interface circuits, and to make electrical connections for those test circuits. However, if the test circuits, matched to the interface circuits, are mounted on a chip, the area of the chip, dedicated to testing, is increased. Further, the interface circuits cannot be tested flexibly, thus deteriorating the testing performance.

In one aspect of the present invention, there is provided a data transmitting apparatus comprising a processor, N sets of external terminals, where N is an integer not less than 2, N interface circuits coupled over a bus to the processor and adapted to transfer data between the processor and the N sets of external terminals, and an interface testing circuit coupled over a bus to the processor and selectively coupled to one of the N sets of external terminals.

The meritorious effects of the present invention are summarized as follows.

According to the present invention, the interface testing circuit selectively couples to any one of the N the external terminals sets to test N interface circuits. Hence, the interface circuits can be tested flexibly, without excessively increasing the chip area that takes part in the testing, thereby improving the testing performance.

### BRIEF DESCRIPTION OF THE DRAWINGS

FIG. 1 is a block diagram showing the structure of a data transmitting apparatus according to the present invention.

FIG. 2 is a block diagram showing the structure of a data transmitting apparatus according to a first example of the present invention.

FIGS. 3A and 3B are schematic views mainly showing data structures in case the interface testing circuit performs an outputting operation.

FIG. 4 is a schematic view mainly showing data structures in case the interface testing circuit performs a receiving operation.

FIG. 5 is a block diagram showing the structure of a data transmitting apparatus according to a second example of the present invention.

FIGS. 6A, 6B, 6C and 6D are schematic views showing several examples of connection channels according to the sorts of the interface circuit.

### PREFERRED MODES OF THE INVENTION

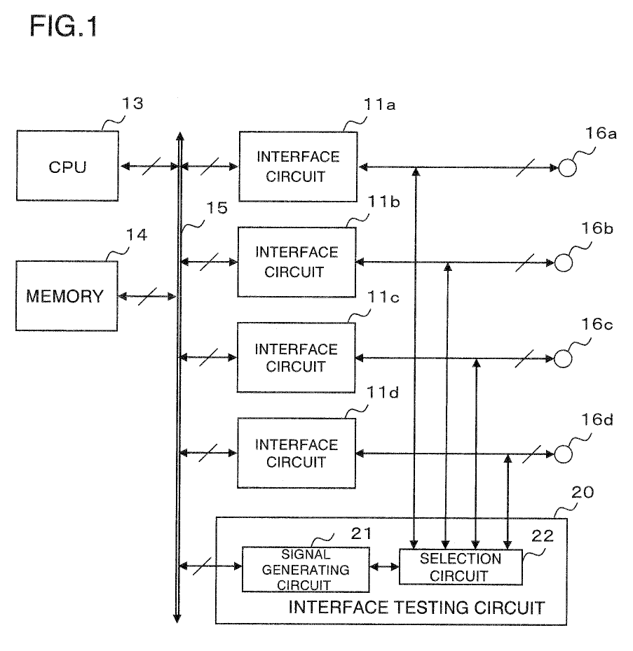

More precisely, there is provided, according to the present invention, a data transmitting apparatus comprising a processor (13 of FIG. 1), N sets of external terminals (16a to 16d of FIG. 1), where N is an integer not less than 2, N interface circuits (11a to 11d of FIG. 1) coupled over a bus to the processor and adapted to transfer data between the processor and the N sets of external terminals, and an interface testing circuit (20 of FIG. 1) coupled over a bus to the processor and selectively coupled to one of the N sets of external terminals.

The interface circuit is adapted to receive data from or to output data to, an associated set of external terminals (external terminal set). The interface testing circuit may include a selection circuit that selects (any) one of the N interface circuits, and selects whether data is to be received from or output to the set of external terminals associated with the selected interface circuit.

The interface testing circuit may be designed and constructed so that, in case the interface circuit operates as an outputting circuit, the interface testing circuit receives and buffers data output by the interface circuit to the associated external terminal set so that the data can be read out by the processor.

The interface testing circuit may be designed and constructed so that, in case the interface circuit operates as a receiving circuit, the interface testing circuit outputs data pre-written and buffered therein by the processor so that the interface circuit will receive the data.

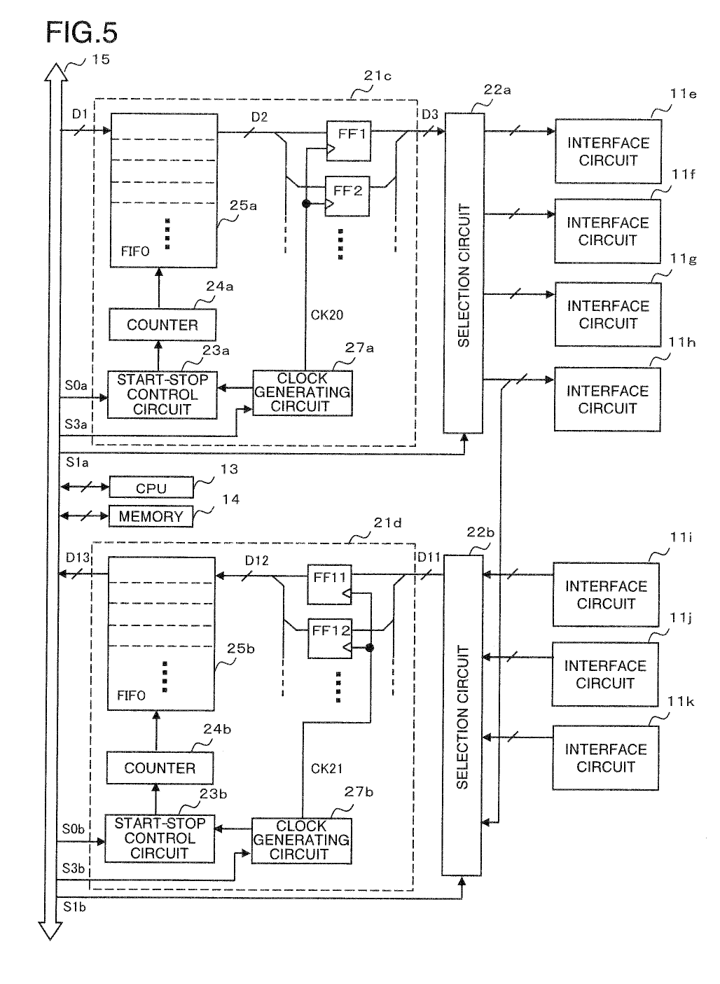

The interface testing circuit may include a signal generating circuit (21d of FIG. 5). The signal generating circuit may include a clock generating circuit (27b of FIG. 5) that generates a sampling clock signal for over-sampling the data output from the interface circuit. The signal generating circuit may sample the data output by the interface circuit with the sampling clock signal, receive the sampled data and hold the received data. The processor can read out data held by the signal generating circuit.

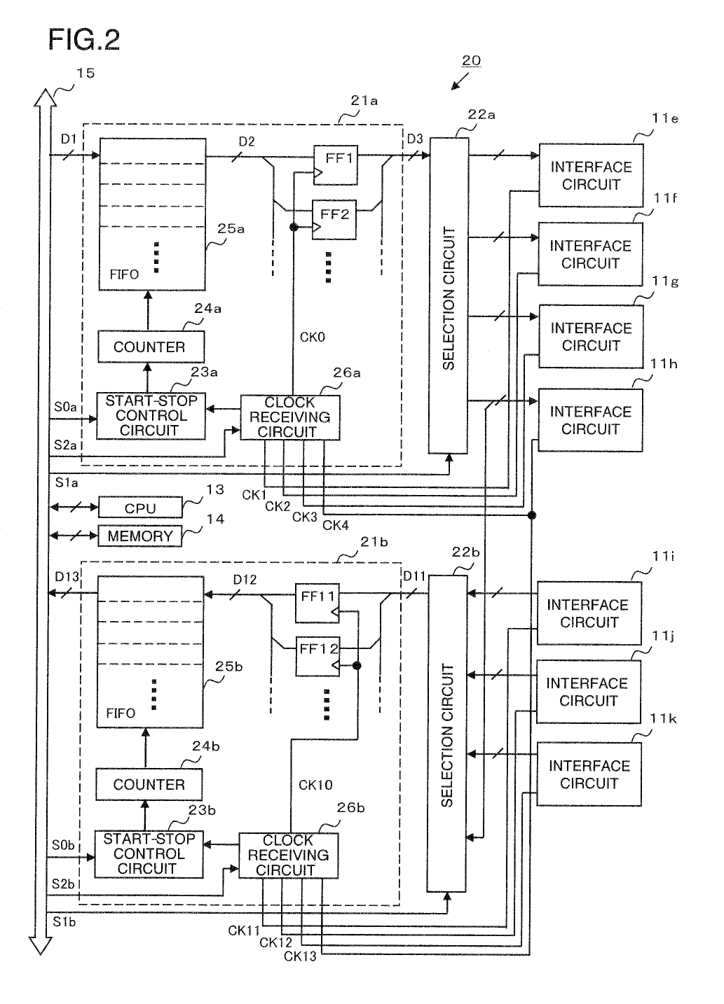

The interface testing circuit may include a signal generating circuit (21b of FIG. 2). The signal generating circuit may include a clock receiving circuit (26b of FIG. 2) for receiving a clock signal synchronized with data output from the interface circuit. The signal generating circuit may receive and hold data output from the interface circuit in synchronization with the clock signal. The processor can read out data held by the signal generating circuit.

The interface testing circuit may include a signal generating circuit (21c of FIG. 5). The signal generating circuit may include a clock generating circuit (27a of FIG. 5) that generates a sampling clock signal for over-sampling the data received by the interface circuit. The signal generating circuit may output the data received by the interface circuit in synchronization with the sampling clock signal. The processor can pre-write data output from the signal generating circuit in the signal generating circuit.

The interface testing circuit may include a signal generating circuit (21a of FIG. 2). The signal generating circuit may include a clock receiving circuit (26a of FIG. 2) that receives a clock signal synchronized with the data received by the interface circuit. The signal generating circuit may output the data received by the interface circuit in synchronization with the sampling clock signal. The processor can pre-write data output from the signal generating circuit in the signal generating circuit.

The above data transmitting apparatus may also be provided on board a semiconductor device.

### EXAMPLES

An example of a data transmitting apparatus of the present invention is now described with reference to the drawings. FIG. 1 depicts a block diagram showing a structure of a data transmitting apparatus according to an example of the present invention. In FIG. 1, the data transmitting apparatus includes interface circuits 11a, 11b, 11c, 11d, a CPU 13, a memory 14, sets of external terminals (external terminal sets) 16a, 16b, 16c and 16d, and an interface testing circuit 20. The interface circuits 11a to 11d, CPU 13, memory 14 and the interface testing circuit 20 are intercoupled over a bus 15. The external terminals sets 16a to 16d are coupled respectively to the interface circuits 11a to 11d, and are each composed of one or more terminals.

The interface circuits 11a to 11d receive serial or parallel data from the external terminals sets 16a, 16b, 16c and 16d, or send out the data to the external terminal sets 16a, 16b, 16c and 16d, under control by the CPU 13. For example, when the interface circuit 11a operates as an outputting circuit, the CPU 13 controls the interface circuit 11a in such a manner that output data of the interface circuit 11a stored in the memory 14 is transferred to the interface circuit 11a and output to outside via the terminal(s) of the external terminal set 16a. When the interface circuit 11b operates as a receiving circuit, the CPU 13 controls the interface circuit 11b to transfer data received from the terminal(s) of the external terminal set 16b via the interface circuit 11b to the memory 14 for storage therein.

The interface testing circuit 20 includes a signal generating circuit 21 and a selection circuit 22. The selection circuit 22 operates under control by the CPU 13 to select (any) one of the interface circuits 11a to 11d and to decide on whether data is to be received from or output to the external terminal set concerned associated with the so selected interface circuit.

The signal generating circuit 21 is so designed and constructed that, when the interface circuit, selected by the selection circuit 22, operates as an outputting circuit, the signal generating circuit will receive data output from this interface circuit and will buffer the so received data in a state readable by the CPU 13. The CPU 13 compares the data written in the interface circuit to the data read out from the signal generating circuit 21 to decide on whether or not the selected interface circuit operates as normally.

Also, when the interface circuit, selected by the selection circuit 22, operates as a receiving circuit, the signal generating circuit 21 operates to buffer therein data already written by the CPU 13. The data buffered by the signal generating circuit 21 is output to the interface circuit as selected by the selection circuit 22. The selected interface circuit receives data output from the selection circuit 22. The CPU 13 compares the data written in the signal generating circuit 21 to the data read out from the selected interface circuit to decide on whether or not the selected interface circuit is operating as normally.

With the data transmitting apparatus, designed and constructed as mentioned above, the interface testing circuit is selectively coupled to (any) one of N external terminal sets to test the N interface circuits. Thus, the interface circuits may be tested flexibly without excessively increasing the size of the chip area of the interface test circuit that takes part in the test. Moreover, since the test is conducted in a closed environment within the apparatus, it is unnecessary to take the influence from the substrate in the course of high speed serial transmission into account. Moreover, testing may be made at a real operating speed of the interface circuits. The functional test may be conducted with ease under the conditions of actual operation at the actual speed, and under the conditions of mass production, thus improving the testing quality and efficiency.

### First Example

FIG. 2 is a block diagram showing the structure of a data transmitting apparatus according to a first example of the present invention. In FIG. 2, the same reference numerals or symbols are used to depict the same components as those shown in FIG. 1 and the description therefor is omitted for simplicity. With the data transmitting apparatus of FIG. 2, the interface testing circuit includes (1) a signal generating circuit 21a and a selection circuit 22a of a signal outputting channel and (2) a signal generating circuit 21b and a selection circuit 22b of a signal receiving channel.

The signal generating circuit 21a of the signal outputting channel includes a start-stop control circuit 23a, a counter 24a, a FIFO 25a, latch circuits FF1, FF2 and so forth, and a clock receiving circuit 26a. To the selection circuit 22a are coupled the interface circuits 11e, 11f, 11g and 11h. It should be noticed that the interface circuits 11e, 11f, 11g and 11h are capable of generating clock signals to be used for strobing data received from outside, not shown. Specifically, it is presumed that the interface circuits 11e, 11f, 11g and 11h are capable of generating clock signals CLK1, CLK2, CLK3 and CLK4, respectively.

The signal generating circuit 21b of the signal receiving channel includes a start-stop control circuit 23b, a counter 24b, a FIFO 25b, latch circuits FF11, FF12 and so forth, and a clock receiving circuit 26b. To the selection circuit 22b of the receiving channel, there are coupled the interface circuits 11i, 11j, 11k and 11h. It should be noted that the interface circuits 11i, 11j, 11k and 11h are capable of generating clock signals used for synchronizing data outputting to outside, not shown. Specifically, it is presumed that the interface circuits 11i, 11j, 11k and 11h are capable of generating clock signals CLK11, CLK12, CLK13 and CLK14, respectively. The interface circuit 11h has the function of receiving/outputting data.

(1) First, a case of a data receiving test for the interface circuit, that is, a case of the interface testing circuit carrying out an outputting operation, is described.

The CPU 13 writes received data, conforming to the communication standard for the interface circuit under test, and which is pre-stored in the memory 14, over the bus 15 to the FIFO 25a. At this time, the CPU 13 sends a control signal S0a to the start-stop control circuit 23a to activate its operation. The counter 24a is then actuated by the start-stop control circuit 23a to permit a preset volume of received data for testing to be written in the FIFO 25a.

The CPU 13 sends to the selection circuit 22a a selection signal S1a indicating which of the interface circuits 11e, 11f, 11g and 11h is to be selected as a test subject.

The CPU 13 then sends to the clock receiving circuit 26a a control signal S2a which controls the clock receiving circuit 26a in such a manner that one of the clock signals CLK1, CLK2, CLK3 and CLK4, associated with the selected interface circuit, respectively, will be selected and delivered as the clock signal CK0 to the start-stop control circuit 23a and to the latch circuits FF1, FF2 and so forth.

With the start-stop control circuit 23a run in operation by the clock receiving circuit 26a, a preset volume of input data for testing is read out by the counter 24a from the FIFO 25a. The so read out input data is latched by the latch circuits FF11, FF12 and so forth, at each clock timing by the clock signal CK0, so as to be delivered to the interface circuit as selected by the selection circuit 22a.

The CPU 13 reads out the input data of the selected interface circuit, and compares the data to the input data for test, stored in the memory 14, in order to verify that the selected interface circuit operates as normally.

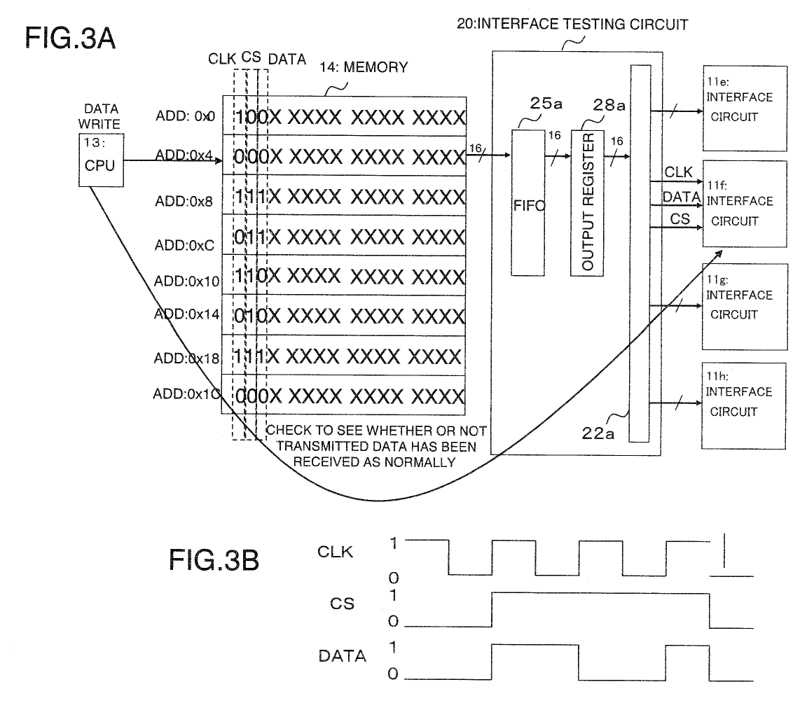

Now, a case where an interface circuit under test receives 1-bit data in synchronization with a clock signal is described. FIG. 3 schematically depicts a data structure for a case where the interface testing circuit performs an outputting operation. It is assumed here that the interface circuit 11f has the function of receiving, as inputs, the clock signal CLK, a 1-bit data signal DATA, synchronized with the clock signal CLK, and a chip select signal CS.

Referring to FIG. 3A, the CPU 13 activates data, conforming to the communication standard for the interface circuit 11f under test, to be written in advance in the memory 14. The data written here is of a 16-bit structure, such as 100xxxxxxxxxxxxx and so forth, in binary notation, where x denotes being undefined. The uppermost bit, corresponding to the leftmost bit in the 16-bit representation, denotes the clock signal CLK, the second bit from the left denotes the chip select signal CS and the third bit from the left denotes the data signal DATA. Such data strings are sequentially written in the FIFO 25a. The data string, written in the FIFO 25a, is delivered to the interface circuit 11f via an output register 28a (latch circuits FF1, FF2 and so forth of FIG. 2) and the selection circuit 22a. It is assumed however that the interface circuit 11f strobes only upper three bits in the data string (clock signal CLK, data signal DATA and the chip select signal CS) without strobing undefined bits.

The interface circuit 11f receives the upper three bits in the data string in accordance with the timing chart shown in FIG. 3B. The CPU 13 accesses the interface circuit 11f and reads out the upper three bits received by the interface circuit 11f to verify whether or not data conforming to the communication standard of the interface circuit 11f has been received.

(2) First, a case of a data outputting test for the interface circuit, that is, a case of the interface testing circuit carrying out a receiving operation, is described with reference to FIG. 2.

The CPU 13 routes (sends) to the selection circuit 22b a selection signal S1b for selecting transmission data output from any one of the interface circuits 11i, 11j, 11k and 11h under test.

The CPU 13 then sends to the clock receiving circuit 26b a control signal S2b which controls the clock receiving circuit 26b in such a manner that one of the clock signals CLK11, CLK12, CLK13 and CLK4, associated with the selected interface circuit, will be selected and delivered as a clock signal CK10 to the start-stop control circuit 23b and to the latch circuits FF11, FF12 and so forth.

The CPU 13 selects one of the interface circuits 11i, 11j, 11k and 11h to write the transmission data in the so selected interface circuit.

The so selected interface circuit delivers the transmission data, written by the CPU 13, to the selection circuit 22b, while outputting a clock signal, indicating an output timing of the transmission data, to the clock receiving circuit 26b.

The CPU 13 sends the control signal S2b to the clock receiving circuit 26b to output the clock signal CK10, associated with the selected interface circuit, to the latch circuits FF11, FF12 and so forth.

The transmission data, latched in the latch circuits FF11, FF12 and so forth, are sequentially written in the FIFO 25b.

The CPU 13 sends a control signal S0b to the start-stop control circuit 23b to activate its operation. The counter 24b is then actuated by the start-stop control circuit 23b to permit a preset volume of the transmission data stored in the FIFO 25b to be read in the memory 14.

The CPU 13 compares the transmission data, supplied to the selected interface circuit, with the transmission data for test, stored in the memory 14, to verify whether or not the interface circuit selected operates as normally.

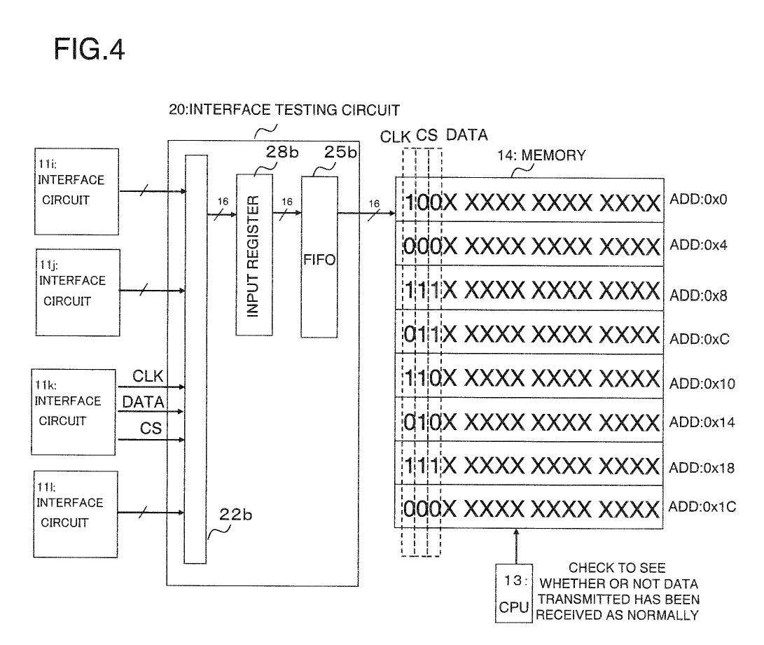

Next, a case where an interface circuit being tested transmits 1-bit data in synchronization with a clock signal is described. FIG. 4 schematically depicts a data structure for a case where the interface testing circuit performs an inputting operation. It is assumed here that the interface circuit 11k has the function of transmitting, as outputs, the clock signal CLK, the 1-bit data signal DATA, synchronized with the clock signal CLK, and the chip select signal CS.

Referring to FIG. 4, the CPU 13 activates output data (transmission data) to be written in the interface circuit 11k under test and actuates the interface circuit 11k. The clock signal CLK, the 1-bit data signal DATA synchronized with the clock signal CLK and the chip select signal CS, are read in the FIFO 25b via the selection circuit 22b and an input register 28b (latch circuits FF11, FF12 and so forth). The data read is of a 16-bit structure, such as 100xxxxxxxxxxxxx and so forth, in binary notation, where x denotes being undefined. The uppermost bit, corresponding to the leftmost bit in the 16-bit representation, denotes the clock signal CLK, the second bit from the left denotes the chip select signal CS and the third bit from the left denotes the data signal DATA. Such data strings are sequentially written in the FIFO 25b. The CPU 13 verifies whether or not the data transferred to the memory 14 is desired data output from the interface circuit 11k, that is, whether or not the data transmitted from the interface circuit 11k has been received as normally.

### Second Example

FIG. 5 is a block diagram showing the structure of a data transmitting apparatus according to a second example of the present invention. In FIG. 5, the same reference numerals or symbols are used to depict the same components as those shown in FIG. 2 and the description therefor is omitted for simplicity. The data transmitting apparatus of FIG. 5 includes signal generating circuits 21c and 21d in place of the signal generating circuits 21a and 21b. The signal generating circuit 21c and the signal generating circuit 21d respectively include a clock generating circuit 27a and a clock generating circuit 27b in place of the clock receiving circuit 26a and the clock receiving circuit 26b.

The clock generating circuit 27a is controlled by a control signal S3a from the CPU 13 to generate a clock signal CK20, which is over-sampled and which thus is sufficiently high in speed as compared to the data inputting speed to the interface circuits 11e, 11f, 11g and 11h. The clock signal CK20 is supplied to the FIFO 25a and to the latch circuits FF1, FF2 and so forth. The one of the interface circuits 11e, 11f, 11g and 11h selected by the selection circuit 22a receives the data stored in the FIFO 25a.

Also, the clock generating circuit 27b is controlled by a control signal S3b from the CPU 13 to generate a clock signal CK21, which is over-sampled and which thus is sufficiently high in speed as compared to the data inputting speed to the interface circuits 11i, 11j, 11k and 11h. The clock signal CK21 is supplied to the FIFO 25b and to the latch circuits FF11, FF12 and so forth. The one of the interface circuits 11i, 11j, 11k and 11h selected by the selection circuit 22b outputs data via the selection circuit 22b to the latch circuits FF11, FF12 and so forth. The data latched by the latch circuits FF11, FF12 and so forth, in synchronization with the clock signal CK21, is stored in the FIFO 25b.

In the data transmitting apparatus, designed and constructed as mentioned above, the interface testing circuit operates for outputting over-sampled data to the interface circuit, while also operating for receiving over-sampled data from the interface circuit. The data transmitting apparatus of the first example is in need of a clock signal for synchronization representing the data input/output timing from the interface circuit. In contrast, the data transmitting apparatus of the second example, receiving/outputting the over-sampled data, is not in need of the clock signal for synchronization.

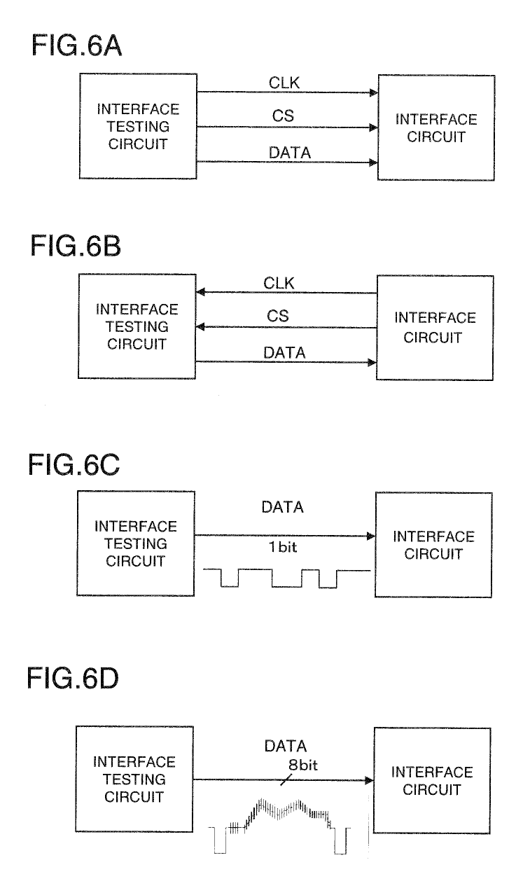

Test data transmission/reception, dependent on the sort of the interface circuit, is now described. FIGS. 6A and 6B shows several examples of channels for connection dependent on the sorts of the interface circuits.

FIG. 6A shows a connection channel for the interface circuit 11f of FIG. 3. An interface testing circuit operates as a master, or a transmitter, and another interface testing circuit operates as a slave, or as a receiver. If, in this case, the interface circuit outputs a synchronization signal for data strobing from outside, the structure of the first example or the second example may be applied.

FIG. 6B shows a connection channel for the interface circuit 11h of FIG. 3. An interface testing circuit operates as a master, or a transmitter, and another interface testing circuit operates as a slave, or as a receiver. If, in this case, the interface circuit outputs a synchronization signal for the data strobing from outside, the structure of the first example or the second example may be applied.

FIG. 6C shows a connection channel in case the interface circuit is a non-synchronizing 1-bit serial receiving circuit. Since the interface circuit in general does not output synchronization signal for data strobing from outside in this case, the structure of the second example is desirably applied.

FIG. 6D shows a connection channel in case the interface circuit is an 8-bit parallel receiving circuit. For example, this connection channel is for the case in which the interface circuit is a video receiving circuit for receiving NTSC signals. Since the interface circuit in general does not output synchronization signals for data strobing from outside in this case, the structure of the second example is desirably applied.

The above four cases are given merely for illustration sake and the present invention may be designed for programmably testing a variety of the interface circuits. Thus, with the data transmitting apparatus according to the present invention, it is possible to flexibly test the interface circuits by setting the interface testing circuit in dependence upon the sorts of the interface circuits. Moreover, since the interface testing circuit provided is programmable, the SOC may be constructed without excessively increasing the chip area of the interface testing circuit used for testing.

Although the present invention has so far been described with reference to preferred examples, the present invention is not to be restricted to the examples. It is to be appreciated that those skilled in the art can change or modify the examples without departing from the scope and spirit of the invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A data transmitting apparatus comprising:
a processor;
N sets of external terminals, where N is an integer not less than 2;
N interface circuits coupled over a bus to said processor and adapted to transfer data between said processor and respective ones said N sets of external terminals; and
an interface testing circuit coupled over a bus to said processor and selectively coupled to one of said N sets of external terminals.

2. The data transmitting apparatus according to claim 1, wherein said interface circuit is adapted to receive data from or to output data to an associated set of external terminals, respectively; and wherein
said interface testing circuit includes a selection circuit that selects one of said N interface circuits, and selects whether data is to be received from or output to the set of external terminals associated with the selected interface circuit.

3. The data transmitting apparatus according to claim 1, wherein said interface testing circuit is designed and constructed so that, in case said interface circuit operates as an outputting circuit, said interface testing circuit receives and buffers data output by said interface circuit to the associated external terminals so that said data can be read out by said processor.

4. The data transmitting apparatus according to claim 1, wherein said interface testing circuit is designed and constructed so that, in case said interface circuit operates as a receiving circuit, said interface testing circuit outputs data pre-written and buffered therein by said processor so that said interface circuit will receive said data.

5. The data transmitting apparatus according to claim 3, wherein said interface testing circuit comprises a signal generating circuit; said signal generating circuit including a clock generating circuit that generates a sampling clock signal for over-sampling data output from said interface circuit; said signal generating circuit sampling the data output by said interface circuit with said sampling clock signal, receiving said sampled data and holding said received data;
said processor reading out data held by said signal generating circuit.

6. The data transmitting apparatus according to claim 3, wherein said interface testing circuit comprises a signal generating circuit, said signal generating circuit including a clock receiving circuit that receives a clock signal synchronized with data output from said interface circuit; said signal generating circuit receiving and holding data output from said interface circuit in synchronization with said clock signal;
said processor reading out data held by said signal generating circuit.

7. The data transmitting apparatus according to claim 4, wherein said interface testing circuit comprises a signal generating circuit; said signal generating circuit including a clock generating circuit that generates a sampling clock signal for over-sampling the data received by said interface circuit; said signal generating circuit outputting the data received by said interface circuit in synchronization with said sampling clock signal;
said processor pre-writing data output from said signal generating circuit in said signal generating circuit.

8. The data transmitting apparatus according to claim 4, wherein said interface testing circuit comprises a signal generating circuit; said signal generating circuit including a clock receiving circuit that receives a clock signal synchronized with the data received by said interface circuit; said signal generating circuit outputting the data received by said interface circuit in synchronization with said clock signal;
said processor pre-writing data output from said signal generating circuit in said signal generating circuit.

9. A semiconductor device including the data transmitting apparatus according to claim 1.
